(19) United States
(12) Patent Application Publication
(10) Pub. No.: US 2020/0043274 A1
(43) Pub. Date: Feb. 6, 2020

(54) APPARATUS FOR PROVIDING LAUNDRY DETERGENT AND RINSE CYCLE BENEFIT AGENT COMPOSITIONS

(71) Applicant: Conopco, Inc., d/b/a UNILEVER, Englewood Cliffs, NJ (US)

(72) Inventors: Benjamin Edward HONE, Lutterworth (GB); Ellen Suzanne PIERCY, Northwich (GB)

(73) Assignee: Conopco, Inc., d/b/a UNILEVER, Englewood Cliffs, NJ (US)

(21) Appl. No.: 16/475,176

(22) PCT Filed: Jan. 10, 2018
(86) PCT No.: PCT/EP2018/050562

§ 371 Date: Jul. 1, 2019

(30) Foreign Application Priority Data
Jan. 20, 2017 (EP) 17152439.0

(51) Int. Cl. G07F 13/06; A47F 1/035; G07F 17/20; D06F 39/02

(52) U.S. Cl. CPC G07F 13/06; A47F 1/035; G07F 17/20; D06F 2216/00; D06F 2202/10; D06F 2202/02; D06F 39/02

(57) ABSTRACT

An apparatus for providing two laundry compositions, a detersive composition (which is used to form a wash liquor in a main wash cycle) and a rinse cycle benefit agent (such as a fabric conditioner) on command, for example in a user's home.

The present invention relates to an apparatus for providing two laundry compositions, a detersive composition (which is used to form a wash liquor in a main wash cycle) and a rinse cycle benefit agent (such as a fabric conditioner) on command, for example in a user's home.

For many consumers, no one laundry product fulfils all of their needs. As a result, many consumers buy and store more than one laundry product. Selections include biological and non-biological products, products specifically formulated for white or colours or wools/silk. In addition to storing these laundry products, consumers often store one or more additional stain removal products and/or benefit agents. In total, this can amount to a relatively large number of bottles/boxes stored in consumers' kitchens, utility rooms, garages or basements. This also requires users to know which product is suitable for each load, and to understand and appreciate when and which additional stain removal products an/ or benefit agents should be used.

Other consumers simply use one laundry product for all loads, regardless of suitability. This can mean that unnecessary enzymes, bleaches etc. are used in so-called refresh washes (where the load is not stained) which may have detrimental effects on fabric care and/or the environment.

Many consumers also fall into habits and either never use fabric conditioner or use fabric conditioner all the time. It is not appropriate to use fabric conditioner with all fabric types and wash loads. For example, fabric conditioner may adversely affect the performance of certain active wear (e.g. clothes containing Gore-Tex™) and the absorbency of towels.

This incompatibility can make consumers wary of using fabric conditioner, meaning that they miss out on the benefits in suitable loads.

The invention relates to an apparatus for dispensing two laundry compositions according to input from a user.

In a first aspect, the invention may provide a laundry product dispensing apparatus comprising a dosing device, the dosing device being for use in the drum of an automatic washing machine, and a dispensing device;
wherein the dispensing device comprises a first reservoir housing a composition comprising a surfactant and a second reservoir housing a benefit agent for use in a rinse cycle, and a dispensing area for locating the dosing device,
and wherein the dispensing device is configured to dispense on command composition from the first reservoir into the dosing device located in the dispensing area and is configured to dispense on command the benefit agent from the second reservoir characterised in that the dispensing device includes a computer module in electronic communication with a user interface which can receive user input comprising fabric data based on one or more of the following criteria:
   (I) stain identity;
   (ii) fabric identity;
   (iii) user requirements; and
   (iv) user preferences;
      and wherein, in response to said user input, the computer module formulates a laundry product recipe bespoke to said user input comprising a surfactant and/or a benefit agent such that the dispensing device dispenses surfactant and/or benefit agent into the dosing device.

In a first aspect, the invention may provide a laundry product dispensing apparatus comprising a dosing device, the dosing device being for use in the drum of an automatic washing machine, and a dispensing device;
wherein the dispensing device comprises a first reservoir housing a composition comprising a surfactant and a second reservoir housing a benefit agent for use in a rinse cycle, and a dispensing area for locating the dosing device,
and wherein the dispensing device is configured to dispense on command composition from the first reservoir into the dosing device located in the dispensing area and is configured to dispense on command the benefit agent from the second reservoir characterised in that said first and second reservoirs comprise pre-filled cartridges that cooperate with the housing of the device, such that the composition in each reservoir is in controllable fluid communication with a nozzle for dispensing the composition into the dosing device, wash liquor of a machine or a pre-mixing chamber.

Preferably the dispensing device comprises a computer module and each reservoir is controllable by means of the computer module.

Preferably the dispensing device includes a computer module in electronic communication with a user interface which can receive user input comprising fabric data based on one or more of the following criteria:
(I) stain identity;
(ii) fabric identity;
(iii) user requirements; and
(iv) user preferences;
   and wherein, in response to said user input, the computer module formulates a laundry product recipe bespoke to said user input comprising a surfactant and/or a benefit agent such that the dispensing device dispenses surfactant and/or benefit agent into the dosing device.

It will be appreciated that the dispensing device may dispense the composition of the first reservoir and the composition of the second reservoir into separate dosing devices. However, preferably, both compositions are dispensed into a single dosing device.

Naturally, as the compositions are used at separate points in the wash cycle, the detersive composition and the rinse cycle benefit agent are segregated in the device.

Preferably, therefore, the dosing device of the apparatus has two segregated chambers: a first chamber into which the composition comprising a surfactant is dispensed from the first reservoir, and a second chamber into which the benefit agent is dispensed from the second reservoir.

According, in some preferred embodiments, the dosing device comprises segregated first and second chambers, and wherein the dosing device and dispensing device are configured such that, when the dosing device is located in the dispensing area of the dispensing device, the dispensing device dispenses on command the composition comprising a surfactant from the first reservoir into the first chamber of the dosing device, and dispenses on command a benefit agent into the second chamber of the dosing device. The benefit agent may be dosed from the second reservoir as described, or where there is more than more benefit agent, from a further reservoir.

Suitable dosing devices are described in EP16193266.0, the contents of which are incorporated by reference in their entirety. EP16193266.0 describes laundry composition dosing devices having a first chamber having a first opening and a segregated second chamber having a second opening, wherein the chambers and openings are configured such that a first laundry composition stored in the first chamber is pourable via the first opening by a user without dispensing a second laundry composition stored in the second chamber. It will be understood that the terms first and second may be switched in context. The first laundry composition as described in EP16193266.0 is the benefit agent, (e.g. fabric conditioner).

In other words, in the context of the present invention, the relative size, shape and orientation of each chamber and its respective opening are such that the contents of the second chamber may be dispensed by pouring, while the contents of the first chamber are retained.

Suitably, the amount of first composition and second composition in the device before tilting (to pour out the, for example, fabric conditioner) is one unit dose of each composition. In this context, one unit dose means the recommended amount of said composition for a single wash program.

In other words, suitably, the chambers and openings are configured such that a unit dose of the benefit agent (for example, fabric conditioner) stored in the second chamber is pourable via the second opening by a user to dispense the unit dose from the device, while retaining a unit dose of a detersive composition stored in the first chamber.

A suitable unit dose of the detersive composition may be 5 to 60 mL, depending on the formulation. For example, the unit dose may be 10 to 40 mL, for example, the unit dose may be 15 to 30 mL.

A suitable unit dose of benefit agent e.g. fabric conditioner may be 5 to 50 mL, depending on the formulation. For example, the unit dose may be 10 to 40 mL, for example, the unit dose may be 10 to 30 mL, for example 10 to 20 mL. Concentrated fabric conditioner compositions in the art currently recommend a 15 mL unit dose.

As a result, both laundry detergent, for use in the wash cycle, and the rinse benefit agent (for example, a fabric conditioner), which is used during a rinse step, may be supplied to the dosing device by the dispensing device. The dosing device is then transported to the washing machine by the user, who pours the fabric conditioner into the appropriate recess in the machine drawer by tipping the device so as to dispense the contents of the second chamber.

The dosing device may have more or indented portions and/or textured or rubberised portions to assist user grip and orientation in use.

Once the rinse cycle benefit agent (for example, fabric conditioner) has been added to the drawer, the device is placed in the washing machine drum with the articles to be laundered, and a washing program is started. As water enters the drum and the basket is agitated, water enters the device via both the first and second openings. The contents of the first chamber are dissolved and a wash liquor is formed. Any residual contents of the second chamber as also dissolved and, at the end of the wash program, the device is completely clean, with no residue of either product.

This provides improved convenience for the user, who does not have to rinse a benefit agent (e.g. fabric conditioner) dispenser or risk residue and mess when storing such a dispenser. The device is placed immediately into the drum which is usually next to or immediately below the drawer (depending on the design of the washing machine) and cleaned during the wash program.

In preferred embodiments, the dosing device has an exterior shape that is substantially spherical. The dosing device may have one or more indented portions and/or textured or rubberised portions to assist user grip and orientation in use. These may be in line with the equator or supplied in the vicinity of the equator but oriented at an angle to assist ergonomic use.

Suitably, the dosing device has a flattened base portion to permit the device to sit on a flat surface, for example when the laundry products are being added to the device, or to rest the device on top of the washing machine or similar before use. In this application, vertical and horizontal descriptions refer to the device in this orientation (upright orientation).

Similarly, any references to hemispheres should be construed with respect to this upright orientation.

In some cases, the device comprises an elongated depressed area either side of the device to accommodate and guide a user's thumb and index finger (forefinger) during use. These may be termed gripping portions. Suitably, these are located such that, when a user's thumb and index finger are located in the depressed areas, the second opening is oriented away from the user's hand, thereby assisting pouring of a benefit agent housed in the second chamber.

However, it will be appreciated that it is not essential that the dosing device has a flattened base portion. The device may additionally or alternatively be supplied with one or more protrusions such as a skirt or feet to permit the device to rest on a surface with rolling. Alternatively, the device may have a rounded base and mate with a separate base to maintain position and orientation when placed down.

Preferably the dosing device is substantially spherical with female forms rather than male protrusions. In other words, any connectors or gripping portions are preferably indentations. This helps to prevent “catching” (entanglement) of clothes during the wash and rinse cycles

Suitably, both the first and second openings are located in the northern hemisphere of the substantially spherical device.

In some embodiments, the first and second openings are located at least 90° apart about a vertical rotation axis of the dosing device.

Put another way, when the device is tipped so as to pour the contents of the second chamber, the angle between the first and second openings measured with respect to the plane in which the device is tilted should be at least 90°.

This relative orientation helps to prevent egress of the detersive composition while the benefit agent e.g. fabric conditioner is being poured.

In other words, it is preferable that the first opening is located in what may be considered the western hemisphere, while the second opening is located in what may be considered the eastern hemisphere. As it is not envisaged that a composition will be poured from the first opening, the first opening may be located near the top of the device (in other words, at the north pole).

Most preferably, the angle is about 180°. In other words, when the device is tipped so as to pour the contents of the second chamber, the first and second openings are approximately in the same plane as the plane in which the device is tilted.

This means that when the device is tilted to pour the contents of the second chamber, the first opening is oriented upwards or away from the direction of pouring.

In other words, the pouring tilt direction for the first opening and chamber (if one were to pour the detersive composition via the first opening) may be considered counter to the pouring tilt direction for the second opening and chamber.

It will be appreciated that the two chambers may be located side by side. For example, in the case of a spherical device, the first chamber may be located substantially or completely in the western hemisphere, while the second chamber may be located substantially or completely in the eastern hemisphere.

Preferably however, the second chamber is located substantially within the first chamber. For example, the second chamber may be provided as a suspended bulb or tube within the second chamber.

Preferably, the second chamber is provided as tubular shape projecting into the first chamber. In other words, the second chamber may be defined by a cylindrical wall and a base projecting part way or completely into the first chamber. In some cases, the second chamber is a tubular shape projecting into the first chamber and contacting the interior wall of the first chamber. This may provide stability and rigidity.

This arrangement may be advantageous because the benefit agent (e.g. fabric conditioner) housed in the second chamber has a higher centre of gravity than the detersive composition housed in the first chamber, thereby assisting pouring.

Preferably, a visual cue is provided to differentiate the first and second chambers and/or first and second openings. For example, the second chamber may have an interior surface which is a different colour to an interior surface of the first chamber and, optionally, to an exterior surface of the device. The colour may carry through to the periphery of the second opening. For example, it may have a coloured collar. The second opening may also be provided with a pouring lip or spout to assisting dispensing the composition.

Suitably, the device is made from one or more plastics materials. All or some of the device may be made using one or more of: blow moulding, injection moulding, and 3D printing.

Of course, it will be appreciated that the device is suitable for being used in the drum of a washing machine during a wash. Preferably, the device is also able to withstand tumble drying.

In some preferred embodiments, the dispensing device houses two different rinse cycle benefit agents, for example, two fabric conditioners. Which, if any, fabric conditioner is dispensed depends on input provided by the user. This means that, for example, the fragrance associated with the load may be chosen based on the wearer of the clothes, the type of load, or simply user whim. For example, the dispensing device may house a fabric conditioner for household linens (bedding, towels) and second for clothing. A user may prefer to use different fragrances for workwear and other clothing, helping to differentiate time at work and leisure time. Some couples may even each have their own preferred fragrances.

According, in some embodiments the dispensing device comprises a further reservoir housing a fabric conditioner, such that the dispensing device houses two separate fabric conditioners, wherein said fabric conditioners do not have the same fragrance.

In other embodiments, the dispensing device may comprise a reservoir housing a benefit agent for use in a rinse cycle, suitably in an unperfumed composition, and one or more reservoirs housing a fragrance (perfume) composition for combination with the benefit agent. For example, the dispensing device may comprise two perfume reservoirs, each housing a different fragrance compositions. The compositions may be combined before, during or after dispensing.

Advantageously, the machine may comprise one or more further reservoirs housing stocks of laundry product components, which may be dispensed with the composition comprising a surfactant of the first reservoir to “fine tune” the detersive laundry product used in the wash cycle.

For example, the machine may comprise a further reservoir housing a composition comprising an enzyme (eg protease, lipases, cellulases, pectate lyase etc.), the machine being configured to dispense on command the composition into the dosing device. Suitably, the composition comprising an enzyme is dispensed into the same chamber of the dosing device as the composition of the first reservoir.

The compositions may be liquid, gel or solid (e.g. powder). Mixtures of liquid, gel and solid may be combined.

The dispensing device provides, on command, a composition from the first reservoir and optionally one or more of the further reservoirs, to provide a detersive laundry product for use in the wash step. This is dispensed into the dosing device.

The or each benefit agent for use in a rinse cycle may be a fabric conditioner. Other benefit agents include (but are not limited to) fragrance compositions (without any fabric softening effect), waterproofing agents, sunscreen agents, fire retardants, and insect repellents, lubricants (including silicones), free perfumes and fragrances, encapsulated perfumes and fragrances, preservatives (e.g. bactericides), dye transfer inhibitors, perfume carriers, anti-bacterial agents, fibre adhesives (eg starch, Polyvinyl acetate), elastomers, anti-microbial agents, deposition agents, softening agents, polyelectrolytes, anti-shrinking agents, anti-wrinkle agents, anti-oxidants, dyes, colorants, shade enhancers, fluorescent agents, anti-corrosion agents, anti-static agents, colour preservatives, fungicides and ironing aids, fabric setting agents e.g. setting polymers, starches and any combination thereof.

### Stocks of Each Composition

In each case, each reservoir suitably may contain a stock of the composition, such that multiple doses of laundry product may be supplied by the device without the need to refill the reservoirs. For example, each reservoir may be sized to house at least 5 doses of the composition, for example, at least 10, at least 15. In some cases, it is about 20. It will be appreciated that different reservoirs may provide different numbers of doses and reservoirs may be different sizes.

The machine may have a computer module (which may also be termed a control module) which may detect the amount of each composition in each reservoir to inform the user the further supplies should be ordered/initiate an automatic reorder via the internet or similar (for example, when a pre-determined number of washes remains).

### User Input

The composition is dispensed by dispensing device under control of the computer module according to input provided. Input may be provided in various ways, for example by the user making choices or providing suggestions, or through sensing a tag or label in the article to be laundered (such as a QR “quick response” code). Preferably, input is provided by the user via a user interface.

Suitably, this input is captured via a user interface on the device or in electronic communication with the device. The device may include a graphical user interface (GUI). For example, the GUI may be presented to the user on a digital screen of the user interface. Input from the user may be captured by the user interface of the device via various user interaction mechanisms including: manipulation of buttons, touch screen, voice commands, gestures or other suitable methods. The computer module may communicate with an external user device such as a mobile phone, tablet or laptop to receive user inputs from a user interface on the external device. Using the interface, the user may select a suitable laundry product combination, or the computer module may select, generate or obtain a combination based on the input (load type, staining, preferences and previous wash history etc.). Combination as used here refers to the detersive composition (which may be the product of more than one reservoir) and, if dispensed, the fabric conditioner. The recipe used to determine the amounts may be obtained from an internal memory within the device, or may be obtained from an external memory accessed, for example, via the internet.

User input comprises fabric data based on one or more of the following criteria:
(I) stain identity;
(ii) fabric identity;
(iii) user requirements; and
(iv) user preferences.

The user interface may include a facility to input data in sets, for example through asking to user to selection certain options or alternatives. Accordingly, the device may have or communicate with a user interface via which the user is able to input data using at least two sets of options. At least one set of options may prompt the user to input stain identity (grass, chocolate, blood etc.). At least one set of options may prompt the user to input fabric colour and/or type. (e.g. cotton, polycotton, polyester). At least one set of options may prompt the user to input the identity of the clothes wearer, with the capacity to store selected preferences for future washes.

Based on the data provided for each of these sets, an algorithm may be employed to determine an optimised formulation, balancing the cleaning needs of certain stains or other factors against others. The algorithm may further determine whether or not the fabric conditioner should be dispensed. The algorithm may be stored and accessed on the computer module of the device, or it may be obtained from an external source such as the internet.

Accordingly, in some cases the computer module is programmed with an algorithm to determine how much product is dosed from each reservoir based on the user input.

Accordingly, in some cases the computer module is programmed to communicate with an external source to access an algorithm and determine how much product is dosed from each reservoir based on the user input.

Each reservoir is preferably in controllable fluid communication with a dispensing nozzle which dispenses into the dosing device chamber(s). The compositions from the various reservoirs may be dispensed directly into the dosing device or, where appropriate, may be dispensed via a pre-mixing chamber, which mixes two or more compositions prior to dispensing. It will be understood that, suitably, the benefit agent (e.g. fabric conditioner, perfume) is dispensed separately, preferably via a separate nozzle.

Accordingly, in some embodiments, the dispensing device has a first nozzle in controllable fluid communication with the first reservoir and a second nozzle in controllable fluid communication with the second reservoir; and the dosing device comprises segregated first and second chambers; wherein the dispensing device and dosing device are configured such that the dosing device engages with the dispensing device when located in the dispensing area to align the first opening with the first nozzle output and the second opening with the second nozzle output.

The dispensing device includes a computer module in electronic communication with a user interface. The user interface may prompts the user to input said fabric data and this may identify the load and/or fabric type, and in response to certain identified load and/or fabric types, warns the user that the selected benefit agent e.g. fabric softener may not be suitable. Suitably, the warning is conveyed via the user interface.

The dispensing device may in response to certain identified load and/or fabric types, not dispense said benefit agent e.g. fabric conditioner regardless of other user input.

Fabric types which may result in a warning or determination not to dispense the benefit agent e.g. fabric conditioner may include, without limitation, waterproofed fabric, fire retardant clothing, microfiber, wicking fabrics, and towelling.

Load types which may result in a warning or determination not to dispense the benefit agent e.g. fabric conditioner may include, without limitation, towels, children's sleepwear (which in some countries may be supplied with a fire retardant treatment), athletic sportswear, and certain categories of work clothes.

In some embodiments, the dispensing device has two reservoirs housing different fabric conditioners. In these embodiments, the dispensing device may include a computer module in electronic communication with a user interface which prompts the user to choose which fabric conditioner is preferred, such that the dispensing device selectively dispenses the selected fabric conditioner on command. Additionally or alternatively, the dispensing device may include a computer module in electronic communication with a user interface which selects the fabric conditioner based on other data inputted, such as load type or wearer, such that the dispensing device selectively dispenses a suitable benefit agent, for example a pre-selected fabric conditioner on command.

### Dispensing

Compositions may be dosed sequentially or concurrently.

Preferably, the rinse benefit agent is dispensed via a separate nozzle. Where a single dosing device (having two segregated chambers) is used, suitably the rinse benefit agent is dispensed via a separate nozzle

In other words, preferably, the dispensing device has a second nozzle via which rinse benefit agent is dispensed, and a first nozzle through which the composition comprising a surfactant of the first reservoir is dispensed. Optionally, the contents of one or more further reservoirs, if present, are dispensed via the first nozzle.

In some cases, the device has a pre-mixing chamber in which two or more compositions may be mixed prior to dispensing via the first nozzle. Individual ingredient compositions may be dispensed into said chamber, where they may be mechanically mixed (by stirring or agitation, for example), or may naturally disperse and mix as each component is added.

The reservoirs may be integral to the housing of the device or, more preferably, they may be provided as pre-filled cartridges that cooperate with the housing of the device, such that the composition in the reservoir is in controllable fluid communication with a nozzle for dispensing the composition into the dosing device, wash liquor of a machine or a pre-mixing chamber.

A reservoir cartridge may have stiff walls. In other words, the cartridge may retain its shape regardless of the amount of laundry product in the reservoir. A reservoir cartridge may have flexible walls. It will be appreciated that the cartridge may be configured to suit the overall design and shape of the dispensing device. Said reservoir cartridge may be, without limitation, a pouch or stiff plastic container.

Each reservoir cartridge may be fixable within the device such that the contents of the reservoir are sealable by a valve. Suitably, therefore, the cartridge comprises mating means configured to engage with complementary mating means on the device such that, when in place, the reservoir cartridge is held securely and laundry product within the reservoir cartridge is contained or released according to whether the valve of the dispensing device is in a closed or open state. In other words, the cartridge may comprise a connecting portion which mates with a complementary connection portion of the machine.

Additionally or alternatively, the contents of the reservoir may be supplied by pressure and/or vacuum generated within the device. It will be appreciated that the device may have a pump to move the compositions from the reservoirs to the dosing nozzle, optionally via a pre-mixing chamber, to be dispensed.

Accordingly, each reservoir cartridge may be fixable to the device by mating means configured to engage with complementary mating means on the device such that, when in place, the reservoir cartridge is held securely and laundry product within the reservoir cartridge is contained or released according to whether the pump is on or off.

In a further aspect, the invention may provide a reservoir cartridge comprising a composition as described here. The cartridge is fixable to the device such that the content of the cartridge is in controllable fluid communication with a device as described herein.

The present invention may further provide methods of using an apparatus as described herein to dispense a laundry product, the method comprising providing input to a computer module.

The present invention further provides methods of doing laundry using an apparatus as described herein.

In a further aspect, the invention provides a method of laundering articles in an automatic washing machine, the method comprising using an apparatus as described herein, the method comprising:
i. locating the dosing device in the dispensing area of the dispensing device;
ii. providing user input to the dispensing device, via the user interface; such that in response to said user input
iii. the computer module formulates a laundry product recipe bespoke to said user input, comprising a surfactant and/or a benefit agent such that the dispensing device supplies a composition comprising a surfactant and/or benefit agent into the dosing device; then
iv. placing the device in the washing machine drum with the articles to be laundered; then
v. starting a wash program
   and wherein the user input comprises fabric data based on one or more of the following criteria:
(I) stain identity;
(ii) fabric identity;
(iii) user requirements; and
(iv) user preferences.

In embodiments, the invention provides a method of laundering articles in an automatic washing machine, the method comprising using an apparatus as described herein, the method comprising:
i. locating the dosing device in the dispensing area of the dispensing device;
ii. providing input to the dispensing device, via a user interface; wherein, in response to said user input
iii. the computer module formulates a laundry product recipe bespoke to said user input, comprising a surfactant and/or a benefit agent such that the dispensing device supplies a benefit agent (for example a fabric conditioner) to the second chamber of the dosing device and supplies a compositing comprising a surfactant to the first chamber of the dosing device; then
iv. positioning the second opening of the device above a drawer recess of the washing machine and tipping the device so as to dispense the benefit agent housed in the second chamber into the drawer recess; then
v. placing the device in the washing machine drum with the articles to be laundered; then
vi. starting a wash program.

The method may comprise providing input to the computer module; then dispensing a composition comprising a surfactant into a first chamber of a dosing device and dispensing a benefit agent (for example a fabric conditioner) into the second chamber of dosing device; then pouring the benefit agent (e.g. fabric conditioner) into the drawer of a washing machine; then placing the dosing device into the drum of the washing machine; then starting a washing machine program.

### DESCRIPTION

The invention will now be described without limitation with reference to the following diagrammatical drawings in which:

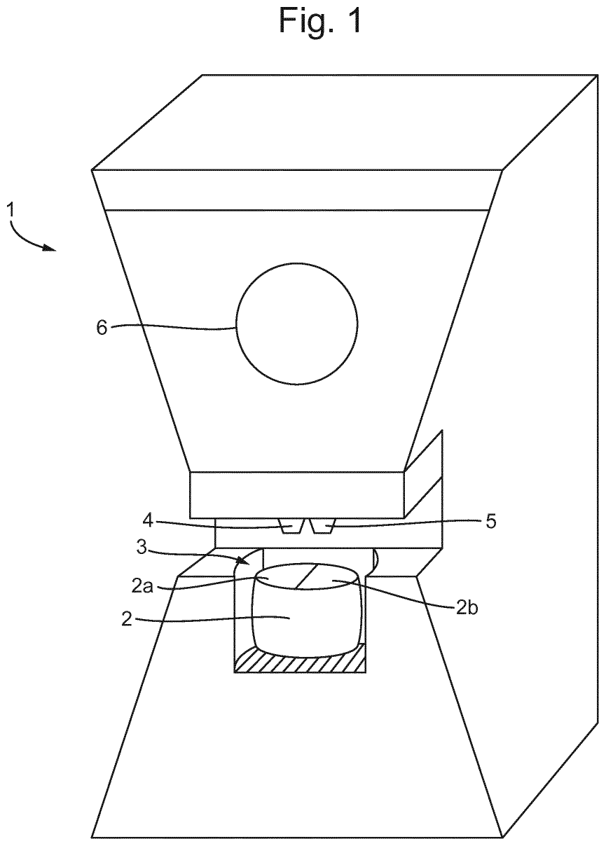

FIG. 1 shows a representative drawing of an apparatus of the invention.

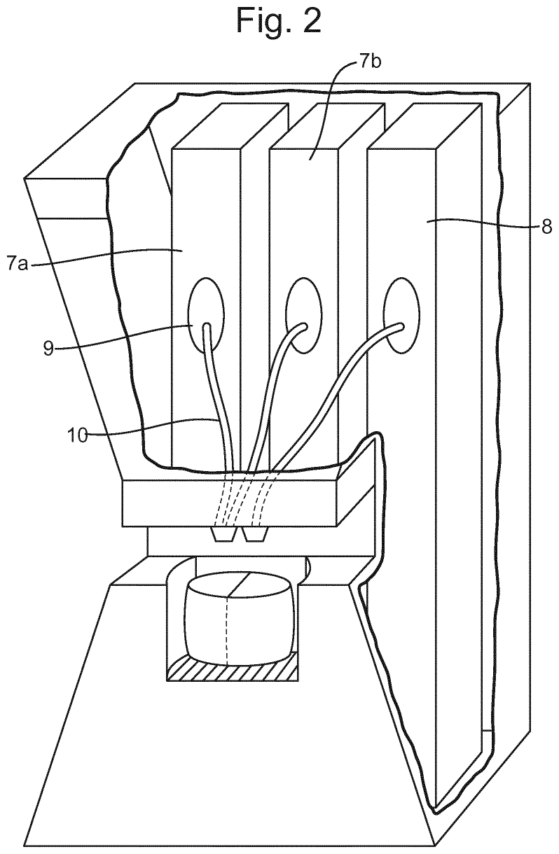

FIG. 2 shows a partially cut away representative drawing of the apparatus of the invention.

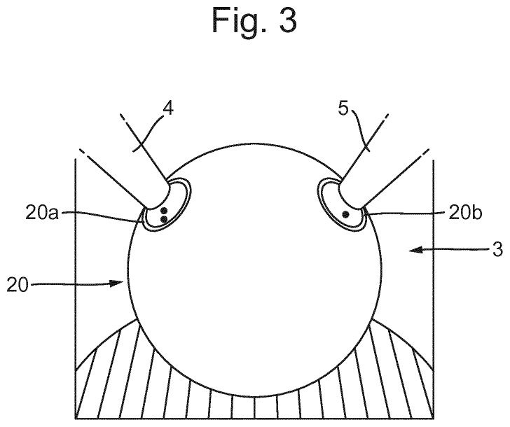

FIG. 3 shows a partial representation of the apparatus, showing only a suitable device in place in the dispensing area 3 of the machine.

The apparatus as illustrated in FIG. 1 has a dispensing device 1 and a dosing device 2. The apparatus is a standalone device, designed to be placed on a countertop or similar.

For example, it may be placed on a countertop in a kitchen or utility room, or may be placed on top of a washing machine.

As illustrated, the dosing device is a two chambered dosing ball, which may be made of plastics material. In use, the dosing device is placed in a dispensing area 3 located underneath nozzles 4 and 5. As illustrated, the dispensing area 3 is a recess provided in the dispensing device housing, and the dosing device 2 is placed on a surface provided in the housing. However, it will be appreciated that the housing may be shaped in different ways such that, for example, the dosing device is placed directly on the countertop (or other surface on which the dispensing device is placed) in use.

A detersive composition is dispensed into the dosing device first chamber 2a via the nozzle 4. This includes the composition comprising the surfactant housed in reservoir 7a (not shown in FIG. 1). It may optionally include compositions from other reservoirs that may be added to the detersive composition such as a composition comprising an enzyme housed in reservoir 7b (not shown in FIG. 1).

If permitted/preferred, a fabric conditioner housed in reservoir 8 (not shown in FIG. 1) is dispensed into the dosing device second chamber 2b via the nozzle 5.

The device has a control/information interface 6. As illustrated, the interface 6 is a touch screen provided in the housing that both displays information and allows selections and information to be inputted to a computer module (not shown).

However, in other embodiments the device may be provided with a panel having buttons, dials or similar for inputting information. In other embodiments, input may be conveyed via spoken command or gesture. It will be appreciated that a screen in the housing of the dispensing device is not essential. The device may be configured for use without a display screen, or an external display screen on for example a phone or tablet may be coupled to the device (for example, via Bluetooth or similar).

FIG. 2 shows a partially cutaway image of the apparatus of FIG. 1. The interior houses three reservoir cartridges (7a, 7b, and 8). It will be appreciated that the arrangement is representative. For example, the cartridges may be provided in on alternative configuration, or may be fixed containers into which a compositions is poured to replenish.

Cartridge 7a is the first reservoir. It houses a composition comprising a surfactant. Cartridge 7b houses a composition comprising an enzyme. Further cartridges housing laundry ingredient compositions may be provided. Cartridge 8 is the second reservoir. It houses a fabric conditioner.

Each cartridge has a valve 9. Each cartridge is in fluid communication with the nozzle via a flow path 10. Flow from the cartridge to the nozzle (where it is dispensed) is controlled by the valve. In this embodiment therefore each valve is a metering valve, with the volume metered controlled by the computer module. It will be appreciated that the valves may be located at any point along the flow path, and other types of valve may be used. It will also be appreciated that metering of the compositions may be achieved in other ways, for example through generation of pressure in the reservoir to force the composition out.

The diagram shows individual flows running from reservoirs 7a and 7b to the nozzle 4. It will be appreciated that flow paths may meet before the nozzle is reached. For example, the device may have a pre-mixing chamber in which different ingredient compositions meet before they are dispensed into the dosing unit. The flow from reservoir 8 (which houses fabric conditioner) runs to a separate nozzle 5.

In use, the dosing device is located under the nozzles, such that the compositions are dispensed into the appropriate chambers. The user inputs information about the laundry load to the computer module. Whether or not to dispense fabric conditioner and, optionally, optimised wash composition may then be determined and the appropriate amount from relevant cartridges dispensed. The computer module (not shown) controls the amounts dispensed.

The criteria used to determine what is dispensed may be obtained from an internal memory within the device, or may be obtained from an external memory accessed, for example, via the internet.

The dosing device 2 is shown, for illustrative purposes, as two mirror image open-topped chambers. However, it will be appreciated that, because the detersive composition and fabric conditioner are used at different points in the wash program, advantageously the dosing device is configured to assist this. Suitably, the device is a device as described in EP16193266.0, the contents of which are incorporated by reference in their entirety. For example, FIG. 3 shows a device as described in EP16193266.0 in place in the dispensing area 3 of the device.

The device 20 has two openings into two separate chambers. As described in EP16193266.0, the dosing device has a fabric conditioner chamber having an opening 20b and a segregated further chamber for the detersive composition having an opening 20a, wherein the chambers and openings are configured such that a fabric conditioner stored in the fabric conditioner chamber is pourable via the opening by a user without dispensing the detersive composition stored in the further chamber. (The first laundry composition as described in EP16193266.0 is the fabric conditioner as described herein.) Accordingly, the opening to chamber 20b resides under nozzle 5 while the opening to chamber 20a resides under nozzle 4.

After dispensing, if the fabric conditioner has been dispensed, the user pours the fabric conditioner from its chamber into the fabric conditioner compartment of the drawer of the washing machine, then places the device (which now contains only the detersive composition) into the drum and starts the program. Naturally, if no fabric conditioner has been dispensed, the step of pouring is omitted.

It is to be understood that the examples and embodiments described herein are for illustrative purposes and that various modifications or changes in light thereof will be suggested to a person skilled in the art and are included in the spirit and scope of the invention and the appended claims.

1. A laundry product dispensing apparatus comprising a dosing device (2), the dosing device being for use in the drum of an automatic washing machine, and a dispensing device (1);
wherein the dispensing device (1) comprises a first reservoir (7a) housing a composition comprising a surfactant and a second reservoir (8) housing a benefit agent for use in a rinse cycle, and a dispensing area (3) for locating the dosing device (2),
and wherein the dispensing device is configured to dispense on command composition from the first reservoir into the dosing device located in the dispensing area and is configured to dispense on command benefit agent from the second reservoir characterised in that the dispensing device includes a computer module in electronic communication with a user interface which can receive user input comprising fabric data based on one or more of the following criteria:
(I) stain identity;
(ii) fabric identity;
(iii) user requirements; and
(iv) user preferences;
and wherein, in response to said user input, the computer module formulates a laundry product recipe bespoke to said user input comprising a surfactant and/or a benefit agent such that the dispensing device dispenses surfactant and/or benefit agent into the dosing device and wherein the dosing device (2) comprises segregated first and second chambers having respective first and second openings, and wherein the dosing device and dispensing device (1) are configured such that, when the dosing device is located in the dispensing area (3) of the dispensing device, the dispensing device dispenses on command the composition comprising a surfactant from the first reservoir (7a) into the first chamber (2a) of the dosing device, and dispenses on command benefit agent into the second chamber (2b) of the dosing device and;
wherein the dispensing device comprises a first nozzle (4) in controllable fluid communication with the first reservoir and a second nozzle (5) in controllable fluid communication with the second reservoir; wherein the dispensing device and dosing device are configured such that the dosing device engages with the dispensing device when located in the dispensing area to align the first opening with the first nozzle output and the second opening with the second nozzle output.

2. A laundry product dispensing apparatus comprising a dosing device, the dosing device being for use in the drum of an automatic washing machine, and a dispensing device;
wherein the dispensing device comprises a first reservoir housing a composition comprising a surfactant and a second reservoir housing a benefit agent for use in a rinse cycle, and a dispensing area for locating the dosing device,
and wherein the dispensing device is configured to dispense on command composition from the first reservoir into the dosing device located in the dispensing area and is configured to dispense on command the benefit agent from the second reservoir characterised in that said first and second reservoirs comprise pre-filled cartridges that cooperate with the housing of the device, such that the composition in each reservoir is in controllable fluid communication with a nozzle for dispensing the composition into the dosing device, wash liquor of a machine or a pre-mixing chamber wherein the dosing device (2) comprises segregated first and second chambers having respective first and second openings, and wherein the dosing device and dispensing device (1) are configured such that, when the dosing device is located in the dispensing area (3) of the dispensing device, the dispensing device dispenses on command the composition comprising a surfactant from the first reservoir (7a) into the first chamber (2a) of the dosing device, and dispenses on command benefit agent into the second chamber (2b) of the dosing device and wherein the dispensing device comprises a first nozzle (4) in controllable fluid communication with the first reservoir and a second nozzle (5) in controllable fluid communication with the second reservoir; wherein the dispensing device and dosing device are configured such that the dosing device engages with the dispensing device when located in the dispensing area to align the first opening with the first nozzle output and the second opening with the second nozzle output.

3. The apparatus of claim 1, wherein the user interface is operative to warn the user that said benefit agent may not be suitable based on said user input.

4. (canceled)

5. (canceled)

6. The apparatus of claim 1, wherein the benefit agent is fabric conditioner.

7. The apparatus of claim 1, wherein the benefit agent is any one of the following:
fragrance compositions (without any fabric softening effect), waterproofing agents, sunscreen agents, fire retardants, and insect repellents, lubricants (including silicones), free perfumes and fragrances, encapsulated perfumes and fragrances, preservatives (e.g. bactericides), dye transfer inhibitors, perfume carriers, anti-bacterial agents, fibre adhesives (eg starch, Polyvinyl acetate), elastomers, anti-microbial agents, deposition agents, softening agents, polyelectrolytes, anti-shrinking agents, anti-wrinkle agents, anti-oxidants, dyes, colorants, shade enhancers, fluorescent agents, anti-corrosion agents, anti-static agents, colour preservatives, fungicides and ironing aids, fabric setting agents e.g. setting polymers, starches and any combination thereof.

8. The apparatus of claim 1, wherein the dispensing device comprises a further reservoir housing a fabric conditioner, such that the dispensing device houses two separate fabric conditioners, wherein said fabric conditioners do not have the same fragrance.

9. The apparatus of claim 1, wherein the dispensing device includes a computer module in electronic communication with a user interface (6) which prompts the user to identify the load and/or fabric type, and in response to certain identified load and/or fabric types, does not dispense fabric conditioner regardless of other user input.

10. The apparatus of claim 1, wherein the dispensing device comprises a graphical user interface configured to receive input from a user, wherein the dispensing device is configured to generate commands based on said input to cause the dispensing device to dispense compositions.

11. The apparatus of claim 1, wherein the dispensing device comprises a further reservoir housing a composition comprising an enzyme (7b), the dispensing device being configured to dispense on command the composition comprising an enzyme into the dosing device.

12. A method of laundering articles in an automatic washing machine, the method comprising using an apparatus according to claim 1 and comprising the steps:
i. locating the dosing device in the dispensing area of the dispensing device;
ii. providing user input to the dispensing device, via the user interface; such that, in response to said user input
iii. the computer module formulates a laundry product recipe bespoke to said user input, comprising a surfactant and/or a benefit agent such that the dispensing device supplies a composition comprising a surfactant and/or benefit agent into the dosing device; then
iv. placing the device in the washing machine drum with the articles to be laundered; then
v. starting a wash program;
and wherein the user input comprises fabric data based on one or more of the following criteria:
(I) stain identity;
(ii) fabric identity;
(iii) user requirements; and
(iv) user preferences.

13. A method of laundering articles in an automatic washing machine, the method comprising using an apparatus according claim 1, and comprising the steps:
i. locating the dosing device in the dispensing area of the dispensing device;
ii. providing input to the dispensing device, via a user interface; wherein, in response to said user input the computer module formulates a laundry product recipe bespoke to said user input, comprising a surfactant and/or a benefit agent such that the dispensing device supplies a benefit agent to the second chamber of the dosing device and supplies a compositing comprising a surfactant to the first chamber of the dosing device; then
iii. positioning the second opening of the device above a drawer recess of the washing machine and tipping the device so as to dispense the benefit agent housed in the second chamber into the drawer recess; then
iv. placing the device in the washing machine drum with the articles to be laundered; then
v. starting a wash program.

14. The method of claim 12, comprising the step of warning the user that said benefit agent may not be suitable based on said user input.

15. The method of claim 13 comprising the step of warning the user that said benefit agent may not be suitable based on said user input.
